(19) United States
(12) Patent Application Publication
(10) Pub. No.: US 2022/0237907 A1
(43) Pub. Date: Jul. 28, 2022

(54) METHOD, APPARATUS, DEVICE, MEDIUM AND PROGRAM FOR IMAGE DETECTION AND RELATED MODEL TRAINING

(71) Applicant: SHENZHEN SENSETIME TECHNOLOGY CO., LTD., Shenzhen (CN)

(72) Inventors: Shixiang TANG, Shenzhen (CN); Guanxiong CAI, Shenzhen (CN); Qingyuan ZHENG, Shenzhen (CN); Dapeng CHEN, Shenzhen (CN); Rui ZHAO, Shenzhen (CN)

(21) Appl. No.: 17/718,585

(22) Filed: Apr. 12, 2022

Related U.S. Application Data
(63) Continuation of application No. PCT/CN2020/135472, filed on Dec. 10, 2020.

(30) Foreign Application Priority Data
Oct. 27, 2020 (CN) 202011167402.2

(51) Int. Cl. G06V 10/82; G06V 10/40; G06V 10/764; G06V 10/74; G06N 7/00

(52) U.S. Cl. CPC G06V 10/82; G06V 10/40; G06N 7/005; G06V 10/761; G06V 10/764

(57) ABSTRACT

A method and apparatus, device, and storage medium for image detection are provided. In the image detection method, image features of a plurality of images and a category relevance of at least one image pair are obtained, wherein the plurality of images include reference images and target images, any two images in the plurality of images form an image pair, and the category relevance indicates a possibility that images in the image pair belong to a same image category; the image features of the plurality of images are updated using the category relevance; and an image category detection result of the target image is obtained using the updated image features.

### CROSS-REFERENCE TO RELATED APPLICATION

This application is a continuation application of International Patent Application No. PCT/CN2020/135472, filed on Dec. 10, 2020, which is based on and claims priority to Chinese patent application No. 202011167402.2, filed on Oct. 27, 2020. The disclosures of International Patent Application No. PCT/CN2020/135472 and Chinese patent application No. 202011167402.2 are hereby incorporated by reference in their entireties.

### BACKGROUND

In recent years, with the development of information technology, image category detection is widely used in many scenarios such as face recognition and video surveillance. For example, in a face recognition scenario, recognition and classification can be performed on several face images based on image category detection, thereby facilitating distinguishing a user-specified face among several face images. Generally speaking, the accuracy of image category detection is usually one of the main indicators for measuring the performance of the image category detection. Therefore, how to improve the accuracy of image category detection becomes a topic of great research value.

### SUMMARY

The disclosure relates to the technical field of image processing, and in particular, to a method, apparatus, device, medium and program for image detection and related model training.

In a first aspect, embodiments of the disclosure provide an image detection method, including: obtaining image features of a plurality of images and a category relevance of at least one image pair, where the plurality of images include reference images and target images, any two images in the plurality of images form an image pair, and the category relevance indicates a possibility that images in the image pair belong to a same image category; updating the image features of the plurality of images using the category relevance; and obtaining an image category detection result of the target image using the updated image features.

In a second aspect, embodiments of the disclosure provide a method for training an image detection model, including: obtaining sample image features of a plurality of sample images and a sample category relevance of at least one sample image pair, where the plurality of sample images includes a sample reference image and a sample target image, any two sample images in the plurality of sample images form a sample image pair, and the sample category relevance indicates a possibility that images in the sample image pair belong to a same image category; updating the sample image features of the plurality of sample images using the sample category relevance based on a first network of the image detection model; obtaining an image category detection result of the sample target image using the updated sample image features based on a second network of the image detection model; and adjusting a network parameter of the image detection model using the image category detection result of the sample target image and an annotated image category of the sample target image.

In a third aspect, embodiments of the disclosure provide an image detection apparatus, including a memory for storing instructions executable by a processor and the processor configured to execute instructions to perform operations of: obtaining image features of a plurality of images and a category relevance of at least one image pair, wherein the plurality of images include reference images and target images, any two images in the plurality of images form an image pair, and the category relevance indicates a possibility that images in the image pair belong to a same image category; updating the image features of the plurality of images using the category relevance; and obtaining an image category detection result of the target image using the updated image features.

In a fourth aspect, embodiments of the disclosure provide an electronic device, including a memory and a processor coupled to each other. The processor is configured to execute program instructions stored in the memory to implement the image detection method in the second aspect.

In a fifth aspect, embodiments of the disclosure provide a non-transitory computer readable storage medium, having program instructions stored thereon, the program instructions, when executed by a processor, implementing the image detection method in the first aspect or the method for training the image detection model in the second aspect.

### BRIEF DESCRIPTION OF THE DRAWINGS

FIG. 1 is a flowchart of an embodiment of an image detection method according to embodiments of the disclosure;

FIG. 2 is a flowchart of another embodiment of an image detection method according to embodiments of the disclosure;

FIG. 3 is a flowchart of yet another embodiment of an image detection method according to embodiments of the disclosure;

FIG. 4 is a state diagram of an embodiment of an image detection method according to embodiments of the disclosure;

FIG. 5 is a flowchart of an embodiment of a method for training an image detection model according to embodiments of the disclosure;

FIG. 6 is a flowchart of another embodiment of a method for training an image detection model according to embodiments of the disclosure;

FIG. 7 is a diagram of a structure of an embodiment of an image detection apparatus according to embodiments of the disclosure;

FIG. 8 is a diagram of a structure of an embodiment of an image detection model training apparatus according to embodiments of the disclosure;

FIG. 9 is a diagram of a structure of an embodiment of an electronic device according to embodiments of the disclosure; and

FIG. 10 is a diagram of a structure of an embodiment of a computer readable storage medium according to embodiments of the disclosure.

### DETAILED DESCRIPTION

Solutions of the embodiments of the disclosure are described below in conjunction with the drawings in the description.

In the following description, for the purpose of illustration rather than limitation, details such as specific system structure, interface and technology are proposed for a thorough understanding of the disclosure.

The terms “system” and “network” herein are generally used interchangeably herein. The term “and/or” herein merely describes an association relationship for describing associated objects and represents that three relationships may exist. For example, A and/or B may represent the following three cases: only A exists, both A and B exist, and only B exists. In addition, the character “/” herein generally indicates an “or” relationship between the associated objects. Furthermore, “a plurality or” herein indicates two or more.

The image detection method provided by the embodiments of the disclosure can be used for detecting image category of images. The image category can be set according to the actual application. For example, in order to distinguish whether an image belongs to “human” or “animal”, the image category can be set to include: human, animal. Alternatively, in order to distinguish whether the image belongs to “male” or “female”, the image category can be set to include: male, female. Alternatively, in order to distinguish whether the image belongs to “white male” or “white female”, or “black male” or “black female”, the image category can be set to include: white male, white female, black male, black female, which is not limited here. In addition, it should be noted that the image detection method provided in the embodiments of the disclosure can be applied to surveillance cameras (or electronic devices such as computers and tablets connected to the surveillance cameras), so that after images are captured, the image detection method provided in the embodiments of the disclosure can be used for detecting the image category to which the image belongs. Alternatively, the image detection method provided in the embodiments of the disclosure can also be applied to electronic devices such as computers and tablets, so that after the images are obtained, the image category to which the image belongs can be detected using the image detection method provided in the embodiments of the disclosure. Reference may be made to the embodiments disclosed below.

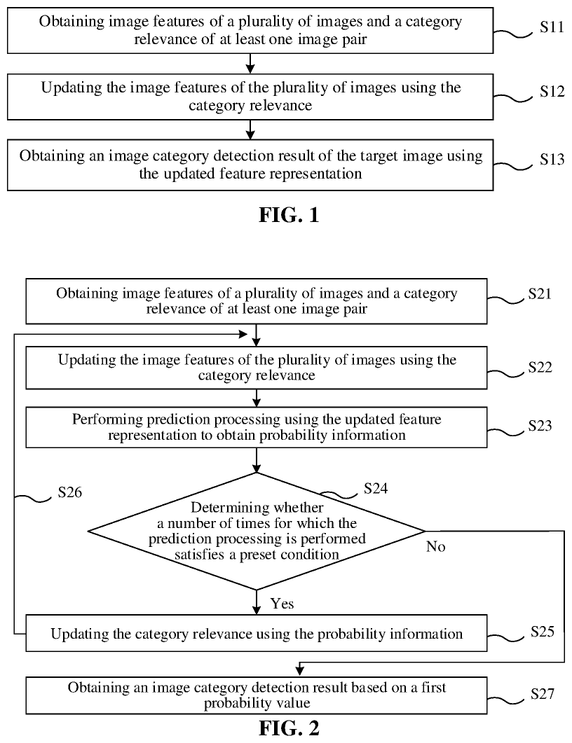

FIG. 1 is a flowchart of an embodiment of an image detection method according to embodiments of the disclosure. The method may include the following steps.

At step S11, image features of a plurality of images and a category relevance of at least one image pair are obtained.

In the embodiments of the disclosure, the plurality of images includes a target image and a reference image. The target image is an image of unknown image category, and the reference image is an image with known image category. For example, the reference image may include: an image with an image category of “white people” and an image with an image category of “black people”. The target image includes a human face, but it is unknown whether the human face belongs to “white people” or “black people”. On this basis, whether the human face belongs to “white people” or “black people” is detected using the steps in the embodiments of the disclosure. Other scenarios can be deduced by parity of reasoning, and no examples are given here.

In an implementation scenario, in order to improve the efficiency of extracting image features, an image detection model can be trained in advance, and the image detection model includes a feature extraction network for extracting image features of the target image and the reference image. For the training process of the feature extraction network, reference can be made to the steps in the method for training the image detection model embodiment provided in the embodiments of the disclosure, and details are not repeated here.

In an actual implementation scenario, the feature extraction network may include a backbone network, a pooling layer, and a fully connected layer that are sequentially connected. The backbone network can be any of a convolutional network and a residual network (e.g., ResNet12). The convolutional network may include several (for example, 4) convolutional blocks, and each convolutional block includes a convolutional layer, a batch normalization layer, and an activation layer (for example, ReLu) that are sequentially connected. In addition, the last several (for example, the last 2) convolutional blocks in the convolutional network may also include a dropout layer. The pooling layer may be a Global Average Pooling (GAP) layer.

In an actual implementation scenario, after the target image and the reference image are processed by the foregoing feature extraction network, image features of preset dimensions (for example, 128 dimensions) can be obtained. The image features can be expressed in the form of vectors.

In the embodiments of the disclosure, any two images in the plurality of images form an image pair. For example, if the plurality of images include a reference image A, a reference image B, and a target image C, the image pair may include: the reference image A and the target image C, the reference image B and the target image C, and other scenarios can be deduced by parity of reasoning, and no examples are given here.

In an implementation scenario, the category relevance of the possibility that the image pair belongs to the same image category may include a final probability value that the image pair belongs to the same image category. For example, when the final probability value is 0.9, it can be considered that the probability that the image pairs belong to the same image category is higher. Alternatively, when the final probability value is 0.1, it can be considered that the probability that the image pairs belong to the same image category is lower. Alternatively, when the final probability value is 0.5, it can be considered that the possibility that the image pairs belong to the same image category and the possibility that the images in the image pair belong to different image categories are equal.

In an actual implementation scenario, when it is started to perform the steps in the embodiments of the disclosure, the category relevance that the image pairs belong to the same image category can be initialized. When the image pairs belong to the same image category, the initial category relevance of the image pair can be determined as a preset upper limit value. For example, when the category relevance is indicated by the final probability value above, the preset upper limit value can be set to 1. In addition, when the images in the image pair belong to different image categories, the initial category relevance of the image pair is determined as a preset lower limit value. For example, when the category relevance is indicated by the final probability value above, the preset lower limit value is set to 0. Furthermore, because the target image is a to-be-detected image, when at least one image of the image pair is the target image, the category relevance that the image pairs belong to the same image category cannot be determined. In order to improve the robustness of initializing the category relevance, the category relevance can be determined as a preset value between the preset lower limit value and the preset upper limit value. For example, when the category relevance is indicated by the final probability value above, the preset value can be set to 0.5. Certainly, it can also be set to 0.4, 0.6, 0.7 as needed, and details are not limited here.

In another actual implementation scenario, for ease of description, when the category relevance is indicated by the final probability value, the initialized final probability value between an i^{th} image and the j^{th} image in the target image and the reference image can be denoted eᵢⱼ⁰. In addition, there are a total of N types of reference images of image categories, and each image category corresponds to K reference images, then when a first image to an NK^{th} image are reference images, the image categories annotated by the i^{th} reference image and the j^{th} reference image can be respectively denoted as yᵢ,yⱼ, and the initialized final probability value that the image pairs belong to the same image category is denoted as eᵢⱼ⁰, which can be expressed as formula (1):

$${e}_{ij}^{0} = \{ \begin{matrix}1 & if {y}_{i} = {y}_{j} , and i , j \leq NK \\ 0 & if {y}_{i} \neq {y}_{j} , and i , j \leq NK \\ 0.5 & if i > NK , and j > NK\end{matrix} . \qquad Formula ( 1 )$$

Therefore, when there are T target images, that is, when the (NK+1)^{th} image to (NK+T)^{th} image are target images, the category relevance of the image pair can be expressed as a matrix of (NK+T)*(NK+T).

In an implementation scenario, the image category can be set according to the actual application scenarios. For example, in a face recognition scenario, the image category can be based on age, and may include: “children”, “teenagers”, “the aged”, etc., or can be based on race and gender, and may include: “white female”, “black female”, “white male”, “black male”, etc. Alternatively, in a medical image classification scenario, the image category can be based on a duration of imaging, and may include: “arterial phase”, “portal phase”, “delayed phase”, etc. Other scenarios can be deduced by parity of reasoning, and no examples are given here.

In a specific implementation scenario, as described above, there are a total of N image categories of reference images, and each image category corresponds to K reference images, N is an integer greater than or equal to 1, and K is an integer greater than or equal to 1. That is, the embodiments of the image detection method of the disclosure can be applied to scenarios where reference images annotated with image categories are relatively rare, for example, medical image classification detection, rare species image classification detection, etc.

In an implementation scenario, the number of target images may be 1. In other implementation scenarios, the number of target images can also be set to multiple according to actual application needs. For example, in the face recognition scenario of video surveillance, image data of a face region detected in each frame contained in the captured video can be used as the target image. In this case, the target image can also be 2, 3, 4, etc. Other scenarios can be deduced by parity of reasoning, and no examples are given here.

At step S12, the image features of the plurality of images are updated using the category relevance.

In an implementation scenario, in order to improve the efficiency of updating image features, as described above, an image detection model can be trained in advance, and the image detection model further includes a Graph Neural Network (GNN). For the training process, reference can be made to relevant steps in the method for training the image detection model embodiment provided by the embodiments of the disclosure, and details are not repeated here. On this basis, the image feature of each image can be used as a node of the input image data of the graph neural network. For ease of description, the image feature obtained by initialization can be denoted as ν₀^{gnn}, and the category relevance of any image pair can be taken as an edge between nodes. For ease of description, the category relevance obtained by initialization can be denoted as ϵ₀^{gnn}, so that the step of updating image features using the category relevance can be executed by using the graph neural network, which can be expressed as formula (2):

ν₁^{gnn}=ƒ(ν₀^{gnn},ε₀^{gnn}) Formula (2).

In the above formula (2), ƒ( )represents the graph neural network, and v₁^{gnn} represents the updated image feature.

In an actual implementation scenario, as described above, when the category relevance of the image pair is expressed as a matrix of (NK+T)*(NK+T), the input image data of the graph neural network can be regarded as a directed graph. In addition, when two images included in any two image pairs do not overlap, the input image data corresponding to the graph neural network can also be regarded as an undirected graph, which is not limited here.

In an implementation scenario, in order to improve the accuracy of image features, an intra-category image feature and an inter-category image features can be obtained using the category relevance and the image features. The intra-category image feature is an image feature obtained by intra-category aggregation of the image features using the category relevance, and the inter-category image feature is an image feature obtained by inter-category aggregation of the image features using the category relevance. For unified description, ν₀^{gnn} still represents the image features obtained by initialization, ε₀^{gnn} represents the category relevance obtained by initialization, then the intra-category image feature can be expressed as ε₀^{gnn}ν₀^{gnn}, and the inter-category image feature can be expressed as (1−ε₀^{gnn})ν₀^{gnn}. After the intra-category image feature and the inter-category image feature are obtained, feature conversion can be performed using the intra-category image feature and the inter-category image feature to obtain the updated image feature. The intra-category image feature and the inter-category image feature can be spliced to obtain a fused image feature. The fused image feature can be converted using a non-linear conversion function ƒ_{θ} to obtain the updated image feature. ƒ_{θ} can be obtained according to formula (3):

ν₁^{gnn}=ƒ₇₄(ε₀^{gnn}ν₀^{gnn}∥(1−ε₀^{gnn})ν₀^{gnn} Formula (3).

In the above formula (3), the parameter of the non-linear conversion function f_{θ} is θ, and ∥ represents a splicing operation.

At step S13, an image category detection result of the target image is obtained using the updated image features.

In an implementation scenario, the image category detection result may be used for indicating the image category to which the target image belongs.

In an implementation scenario, after the updated image features are obtained, prediction processing can be performed using the updated image features to obtain probability information, and the probability information includes a first probability value that the target image belongs to at least one reference category, thereby obtaining the image category detection result based on the first probability value. The reference category is an image category to which the reference image belongs. For example, if the plurality of images include a reference image A, a reference image B, and a target image C, the image category to which the reference image A belongs is “black people”, and the image category to which the reference image B belongs is “white people”, then at least one reference category includes: “black people” and “white people”. Alternatively, the plurality of images includes a reference image A1, a reference image A2, a reference image A3, a reference image A4, and a target image C. The image category to which the reference image A1 belongs is the “plain scan phase”, the image category to which the reference image A2 belongs is the “arterial phase”, the image category to which the reference image A3 belongs is the “portal phase”, and the image category to which the reference image A4 belongs is the “delayed phase”, then at least one reference category includes: “plain scan period”, “arterial phase”, “portal phase” and “delayed phase”. Other scenarios can be deduced by parity of reasoning, and no examples are given here.

In an actual implementation scenario, in order to improve the prediction efficiency, as described above, an image detection model can be trained in advance, and the image detection model includes a Conditional Random Field (CRF) network. For the training process, reference is made to the related description in the method for training the image detection model embodiment provided in the embodiments of the disclosure, and details are not repeated here. In this case, a first probability value that the target image belongs to at least one reference category is predicted using the updated image features based on a Conditional Random Field (CRF) network.

In another actual implementation scenario, the probability information including the first probability value can be directly used as the image category detection result of the target image for user reference. For example, in the face recognition scenario, the first probability value that the target image belongs to “white male”, “white female”, “black male” and “black female” can be taken as the image category detection result of the target image. Alternatively, in the medical image category detection scenario, the first probability value that the target image separately belongs to the “arterial phase”, “portal phase” and “delayed phase” can be taken as the image category detection result of the target image. Other scenarios can be deduced by parity of reasoning, and no examples are given here.

In yet another actual implementation scenario, the image category of the target image may also be determined based on the first probability value that the target image belongs to at least one reference category, and the determined image category is taken as the image category detection result of the target image. The reference category corresponding to the highest first probability value may be taken as the image category of the target image. For example, in the face recognition scenario, the first probability value that the target image separately belongs to “white male”, “white female”, “black male” and “black female” is predicted to be: 0.1, 0.7, 0.1, 0.1, then the “white female” can be taken as the image category of the target image. Alternatively, in the medical image category detection scenario, the first probability value that the target image separately belongs to the “arterial phase”, “portal phase” and “delayed phase” is predicted to be: 0.1, 0.8, 0.1, the “portal phase” can be taken as the image category of the target image. Other scenarios can be deduced by parity of reasoning, and no examples are given here.

In another implementation scenario, prediction processing is performed using the updated image features to obtain probability information, and the probability information includes a first probability value that the target image belongs to at least one reference category and a second probability value that the reference image belongs to at least one reference category. When the number of times for which the prediction processing is performed satisfies a preset condition, the category relevance of the plurality of images can be updated using the probability information, and step S12 and subsequent steps are re-performed, i.e., the steps of updating the image features using the category relevance, and performing the prediction processing using the updated image feature, until the number of times for which the prediction processing is performed does not satisfy the preset condition.

In the above manner, when the number of times for which the prediction processing is performed satisfies the preset condition, the category relevance representing the image pair is updated using the first probability value that the target image belongs to at least one reference category and the second probability value that the reference image belongs to at least one reference category, thereby improving the robustness of category similarity, and the image features are updated using the updated category similarity, thereby improving the robustness of image features, and thus enabling category similarity and image features to promote each other and complement each other, which facilitates further improving the accuracy of image category detection.

In an actual implementation scenario, the preset condition may include: the number of times for which the prediction processing is performed does not reach a preset threshold. The preset threshold is at least 1, for example, 1, 2, and 3, which is not limited here.

In another actual implementation scenario, when the number of times for which the prediction processing is performed does not satisfy the preset condition, the image category detection result of the target image may be obtained based on the first probability value. Reference can be made to the foregoing related descriptions, and details are not repeated here. In addition, for the process of updating the category relevance using probability information, reference can be made to the relevant steps in the following disclosed embodiments, and details are not repeated here.

In an implementation scenario, still taking the face recognition scenario of video surveillance as an example, the image data of the face region detected in each frame contained in the captured video is taken as several target images, and a white male face image, a white female face image, a black male face image, and a black female face image are given as reference images, so that any two images in the reference images and target images form an image pair, and the initial category relevance of the image pair is obtained. At the same time, the initial image features of each image are extracted, and then the image features of the plurality of images are updated using the category relevance, to obtain the image category detection result of the several target images, e.g., the first probability value that the several target images respectively belong to the “white male”, “white female”, “black male”, and “black female” using the updated image features. Alternatively, taking medical image classification as an example, several medical images obtained by scanning a to-be-detected object (such as a patient) are taken as several target images, and a medical image in the arterial phase, a medical image in the portal phase and a medical image in the delayed phase are given as reference images, so that any two images in the reference images and target images form an image pair, and the initial category relevance of the image pair can be obtained. At the same time, the initial image features of each image can be extracted, and then the image features of the plurality of images are updated using the category relevance, and the image category detection results of the several target images are obtained using the updated image features, e.g., the first probability value that the several target images belong to the “arterial phase”, “portal phase”, and “delayed period” respectively. Other scenarios can be deduced by parity of reasoning, and no examples are given here.

In the solution above, image features of a plurality of images and a category relevance of at least one image pair are obtained, the plurality of images include reference images and target images, any two images in the plurality of images form an image pair, and the category relevance indicates a possibility that images in the image pair belong to a same image category, the image features are updated using the category relevance, and an image category detection result of the target image is obtained using the updated image features. Therefore, by updating image features using category relevance, image features corresponding to images of the same image category can be made closer, and image features corresponding to images of different image categories can be divergent, which facilitates improving robustness of the image features, and capturing the distribution of image features, and in turn facilitates improving the accuracy of image category detection.

FIG. 2 is a flowchart of another embodiment of an image detection method according to embodiments of the disclosure. The method may include the following steps.

At step S21, image features of a plurality of images and a category relevance of at least one image pair are obtained.

In the embodiments of the disclosure, the plurality of images include reference images and target images, any two images in the plurality of images form an image pair, and the category relevance indicates a possibility that images in the image pair belong to a same image category. Reference can be made to the related steps in the embodiments disclosed above, and details are not repeated here.

At step S22, the image features of the plurality of images are updated using the category relevance.

Reference can be made to the related steps in the embodiments disclosed above, and details are not repeated here.

At step S23, prediction processing is performed using the updated image features to obtain probability information.

In the embodiments of the disclosure, the probability information includes a first probability value that the target image belongs to at least one reference category and a second probability value that the reference image belongs to at least one reference category. The reference category is an image category to which the reference image belongs. Reference can be made to the related description in the embodiments described above, and details are not repeated here.

The prediction category to which the target image and the reference image belong is predicted using the updated image features, and the prediction category belongs to at least one reference category. Taking the face recognition scenario as an example, when at least one reference category includes: “white male”, “white female”, “black male”, and “black female”, the prediction categories are “white male”, “white female”, “black male” and “black female”. Alternatively, taking the medical image category detection as an example, when at least one reference category includes: “arterial phase”, “portal phase”, and “delayed phase”, the prediction category is any one of the “arterial phase”, “portal phase”, and “delayed phase”. Other scenarios can be deduced by parity of reasoning, and no examples are given here.

After the reference category is obtained, for each image pair, a category comparison result and a feature similarity of the image pair are obtained, and a first matching degree between the category comparison result and the feature similarity of the image pair is obtained. The category comparison result indicates whether respective prediction categories to which the images in the image pair belong are the same, and the feature similarity indicates a similarity between image features of the images in the image pair. Moreover, a second matching degree between the prediction category and the reference category of the reference image is obtained based on the prediction category to which the reference image belongs and the reference category, to obtain the probability information using the first matching degree and the second matching degree.

In the above manner, by obtaining the first matching degree between the category comparison result and the similarity of the image pair, the accuracy of image category detection can be characterized from the dimension of any image pair based on the matching degree between the category comparison result of the prediction category and the feature similarity. By obtaining the second matching degree between the prediction category and the reference category of the reference image, the accuracy of image category detection can be characterized from the dimension of a single image based on the matching degree between the prediction category and the reference category. The probability information is obtained by combining any two images and two dimensions of a single image, which facilitates improving the accuracy of probability information prediction.

In an implementation scenario, in order to improve prediction efficiency, the prediction category to which the image belongs is predicted using the updated image features based on a conditional random field network.

In an implementation scenario, when the category comparison result is that the prediction categories are the same, the feature similarity is positively correlated with the first matching degree. That is, the greater the feature similarity is, the greater the first matching degree is, and the more the category comparison result matches the feature similarity. On the contrary, the smaller the feature similarity is, the smaller the first matching degree is, and the less the category comparison result matches the feature similarity. However, when the category comparison result is that the prediction categories are different, the feature similarity is negatively correlated with the first matching degree. That is, the greater the feature similarity is, the smaller the first matching degree is, and the less the category comparison result matches the feature similarity. On the contrary, the smaller the feature similarity is, the greater the first matching degree is, and the more the category comparison result matches the feature similarity. The method above can facilitate capturing the possibility that the image category between the image pairs is the same in the subsequent prediction process of the probability information, thereby improving the accuracy of probability information prediction.

In an actual implementation scenario, for ease of description, a random variable u can be set for the image features of the target image and the reference image. Furthermore, a random variable in the l^{th} prediction processing can be denoted as u^{th}. For example, a random variable corresponding to an image feature of an i^{th} image in the first to NK^{th} reference images and the (NK+1)^{th} to (NK+T)^{th} target images can be denoted as uᵢ. Similarly, a random variable corresponding to an image feature of a j^{th} image can be denoted as uⱼ. The value of the random variable is the prediction category predicted by using the corresponding image feature, and the prediction category can be represented by serial numbers of N image categories. Taking the face recognition scenario as an example, N image categories include: “white male”, “white female”, “black male” and “black female”. When the value of the random variable is 1, it represents that the corresponding prediction category is “white male”. When the value of the random variable is 2, it represents that the corresponding prediction category is “white female”, and so on, and no examples are given here. Therefore, in the l^{th} prediction processing, when the value of the random variable uᵢ^{l} corresponding to the image feature of one of the image pairs (i.e., the corresponding prediction category) is m (i.e., the m^{th} image category), and the value of the random variable uⱼ^{l} corresponding to the image feature of another image pair (i.e., the corresponding prediction category) is n (i.e., the n^{th} image category), the corresponding first matching degree can be denoted as ϕ(uᵢ^{l}=m, uⱼ^{l}=n), which can be expressed as formula (4):

$$ϕ ( {u}_{i}^{l} = m , {u}_{j}^{l} = n ) = \{ \begin{matrix}{t}_{ij}^{l} & if m = n \\ ( 1 - {t}_{ij}^{l} ) \text{/} ( N - 1 ) & if m \neq n\end{matrix} . \qquad Formula ( 4 )$$

In the above formula (4), tᵢⱼ^{l} represents a feature similarity between the image feature of the i^{th} image and the image feature of the j^{th} image in the l^{th} prediction processing. tᵢⱼ^{l} can be obtained by a cosine distance. For ease of description, in the l^{th} prediction processing, the image feature of the i^{th} image can be denoted as νᵢ^{l}, and in the l^{th} prediction processing, the image feature of the j^{th} image can be denoted as νⱼ^{l}, then the feature similarity between the two image features can be obtained using the cosine distance, and normalized to the range of 0-1, which can be expressed as formula (5):

$${t}_{ij}^{l} = 0.5 [ 1 + \frac{{v}_{i}^{l} {v}_{j}^{l}}{‖ {v}_{i}^{l} ‖ \cdot ‖ {v}_{j}^{l} ‖} ] . \qquad Formula ( 5 )$$

In the above formula (5), ∥·∥ represents a modulus of the image feature.

In another implementation scenario, a second matching degree between the reference images when the prediction category is the same as the reference category is greater than a second matching degree between the reference images when the prediction category is different from the reference category. The method above can facilitate capturing the accuracy of the image category of a single image in the subsequent prediction process of the probability information, thereby improving the accuracy of probability information prediction.

In an actual implementation scenario, as described above, in the l^{th} prediction processing, the random variable corresponding to the image feature of the image can be denoted as u^{l}. For example, the random variable corresponding to the image feature of the i^{th} image can be denoted as uᵢ^{l}, and the value of the random variable is the prediction category predicted by using the corresponding image features. As described above, the prediction category can be represented by the serial numbers of the N image categories. In addition, the image category annotated by the i^{th} image can be denoted as yᵢ. Therefore, when the value of the random variable uᵢ^{l} corresponding to the image feature of the reference image (i.e., the corresponding prediction category) is m (i.e., the m^{th} image category), the corresponding second matching degree can be denoted as ψ(νᵢ^{l}=m), which can be expressed as formula (6):

$$ψ ( {u}_{i}^{l} = m ) = \{ \begin{matrix}1 - σ & if m = {y}_{i} \\ σ \text{/} ( N - 1 ) & if m \neq {y}_{i}\end{matrix} . \qquad Formula ( 6 )$$

In the above formula (6), σ represents a tolerance probability when the value of the random variable (i.e., the predicted category) is wrong (i.e., different from the reference category). σ can be set to be less than a preset numerical threshold. For example, σ can be set to 0.14, which is not limited here.

In an implementation scenario, in the l^{th} prediction processing, the conditional distribution can be obtained based on the first matching degree and the second matching degree, which can be expressed as formula (7):

$$P ( {u}_{1}^{l} , {u}_{2}^{l} , ⋯ , {u}_{NK + T}^{l} \vert {𝓎}_{0} ) ∝ {\prod }_{j = 1}^{NK} ψ ( {u}_{j}^{l} ) {Π}_{< j , k > ∈ {ɛ}_{l}^{crf}} ϕ ( {u}_{j}^{l} , {u}_{k}^{l} ) . \qquad Formula ( 7 )$$

In the above formula (7), <j, k > represents a pair of random variables uⱼ^{l} and uₖ^{l} , and j<k, ∝ represents a positive correlation. It can be seen from formula (7) that when the first matching degree and the second matching degree are higher, the conditional distribution may be larger accordingly. On this basis, for each image, the probability information of the corresponding image can be obtained by summing the conditional distributions corresponding to the random variables corresponding to all images except the image, which can be expressed as formula (8):

$$P ( {u}_{i}^{l} \vert {𝓎}_{0} ) ∝ {Σ}_{{v}_{l}^{crf} \backslash \{ {u}_{i}^{l} \}} P ( {u}_{1}^{l} , {u}_{2}^{l} , ⋯ , {u}_{NK + T}^{l} \vert {𝓎}_{0} ) . \qquad Formula ( 8 )$$

In the above formula (8), P(uᵢ^{l}=m| [symbol] ₀)=p_{i,m}^{l}, represents a probability value that the image category of the random variable uᵢ^{l} the m^{th} reference category. In addition, for ease of description, the random variables corresponding to all images in the l^{th} prediction processing are expressed as νₗ^{crf}, where νₗ^{crf}={uᵢ^{l}}ᵢ₌₁^{NK+T}, as described above, uᵢ^{l} represents a random variable corresponding to the image feature of the i^{th} image in the l^{th} prediction processing.

In another implementation scenario, in order to improve the accuracy of probability information, based on Loopy Belief Propagation (LBP), the probability information can be obtained using the first matching degree and the second matching degree. For the random variable uᵢ^{l} corresponding to the image feature of the i^{th} image in the l^{th} prediction processing, the probability information is denoted as b′_{l,i}. In particular, the probability information b′_{l,i} can be regarded as a column vector, and a j^{th} element of the column vector represents a probability value of the random variable uᵢ^{l} taking the value j. Therefore, an initial value (bₗ, i)⁰ can be given, and b′_{l,i} can be updated t times through the following rules until convergence:

$$\begin{matrix}{m}_{l , i \to j}^{t} = [ ϕ ( {u}_{i}^{l} , {u}_{j}^{l} ) ( {( {b}_{i , l} )}^{t - 1} \text{/} {m}_{l , j \to i}^{t - 1} ) ] , and & Formula ( 9 ) \\ {( {b}_{l , j} )}^{t} ∝ \{ \begin{matrix}ψ ( {u}_{j}^{l} ) {Π}_{i ∈ {𝒩}_{j}} {m}_{l , i \to j}^{t} & if j \leq NK , \\ {Π}_{i ∈ {𝒩}_{j}} {m}_{l , i \to j}^{t} & if j > NK\end{matrix} . & Formula ( 10 )\end{matrix}$$

In the above formulas (9) and (10), m_{l,i→j}^{t} represents a 1*N matrix containing information from random variables uᵢ^{l} to uⱼ^{l} information, ϕ_{i,j}^{l} represents the first matching degree, ϕ(uⱼ^{l} ) represents the second matching degree, [symbol] represents random variables other than the random variable uⱼ^{l}, and

$${Π}_{i ∈ {𝒩}_{j}} {m}_{l , i \to j}^{t}$$

represents multiplication of the corresponding elements of the matrix. [ ] represents a normalization function, which indicates that the matrix elements in the symbol [ ] are divided by the sum of all elements. In addition, when j>NK, it represents the random variable corresponding to the target image. Because the image category of the target image is unknown, the second matching degree is unknown. When the final iteration converges after t′ times, the corresponding probability information b′_{l,i}=(b_{l,i})_{t′}.

At step S24, whether the number of times for which the prediction processing is performed satisfies a preset condition or not is determined, if the preset condition is satisfied, step S25 is executed, and if the preset condition is not satisfied, step S27 is executed.

The preset condition may include: the number of times for which the prediction processing is performed does not reach a preset threshold. The preset threshold is at least 1, for example, 1, 2, and 3, which is not limited here.

At step S25, the category relevance is updated using the probability information.

In the embodiments of the disclosure, as described above, the category relevance may include a final probability value that each pair of image pairs belongs to the same image category. For ease of description, the updated category relevance after the l^{th} prediction processing can be denoted as εₗ^{gnn}. In particular, as described above, before the first prediction processing, the category relevance obtained through initialization can be denoted as ε₀^{gnn} . In addition, furthermore, the final probability value that the i^{th} image and the j^{th} image included in the category relevance εₗ^{gnn} belong to the same image category can be denoted as eᵢⱼ^{l}. In particular, the final probability value that the image i^{th} and the j^{th} image included in the category relevance ε₀^{gnn} belong to the same image category can be denoted as eᵢⱼ⁰.

On this basis, each of the plurality of images can be used as the current image, and the image pair containing the current image can be used as the current image pair. In the l^{th} t prediction processing, the first probability value and the second probability value can be used, to respectively obtain the reference probability value that the images in each image pair of current image pairs belong to the same image category. Taking the current image pair including the i^{th} image and the j^{th} image as an example, the reference probability value êᵢⱼ^{l} can be determined through formula (11):

êᵢⱼ^{l}=P(uᵢ^{l}=uⱼ^{l})=Σₘ₌₁^{N}P(uᵢ^{l}=m)P(uⱼ^{l}=m) Formula (11).

In the above formula (11), N represents the number of at least one image category, and the above formula (11) represents, for the i^{th} image and the j^{th} image, the sum of a product of the probabilities of the same value is taken by obtaining corresponding random variables of the two images. Still taking the face recognition scenario as an example, when N image categories include: “white male”, “white female”, “black male”, and “black female”, the i^{th} image and the j^{th} image can be predicted as a product of the probability values of “white male”, predicted as a product of the probability values of “white female”, predicted as a product of probability values of “black male”, and predicted as a product of probability values of “black female” for summation as the reference probability value that the i^{th} image and the j^{th} image belong to the same image category. Other scenarios can be deduced by parity of reasoning, and no examples are given here.

Meanwhile, a sum of the final probability values of all the current image pairs of the current image can be obtained as a probability sum of the current image. For the l^{th} prediction processing, the updated category relevance can be expressed as εₗ^{gnn}, and the category relevance before the update can be expressed as εₗ₋₁^{gnn}, that is, the final probability value that the i^{th} image and the j^{th} image included in the category relevance εₗ₋₁^{gnn} before the update belongs to the same image category can be denoted as eᵢⱼ^{l-1}. Therefore, for the current image as the i^{th} image, when the other image in the image pair containing the i^{th} image is denoted as k, the sum of the final probability values of all current image pairs of the current image can be expressed as Σₖeᵢₖ^{l-1}.

After the reference probability value and the probability sum are obtained, for each image pair of current image pairs, the final probability value of each image pair can be adjusted respectively using the probability sum and the reference probability value. The final probability value of the image pair can be used as the weight, and weighted processing (e.g., weighted average) can be performed on the reference probability value of the image pair obtained in the last prediction processing using the weight, and the final probability value eᵢⱼ^{l-1} is updated using a weighted processing result and the probability value to obtain the updated final probability value eᵢⱼ^{l} in the l^{th} prediction processing. It can be determined through formula (12):

$${e}_{ij}^{l} ← \frac{{\hat{e}}_{ij}^{l} {e}_{ij}^{l - 1}}{{Σ}_{k} {e}_{ik}^{l - 1} {\hat{e}}_{ik}^{l - 1} \text{/} {Σ}_{k} {e}_{ik}^{l - 1}} . \qquad Formula ( 12 )$$

In the above formula (12), the i^{th} image represents the current image, the i^{th} image and the j^{th} image form a pair of current images, and êᵢₖ^{l-1} represents a reference probability value of an image pair containing the i^{th} image obtained by a (l−1)^{th} prediction processing, êᵢⱼ^{l} represents a reference probability value that the i^{th} image and the j^{th} image obtained in the l^{th} prediction processing belong to the same image category, eᵢⱼ^{l-1} represents a final probability value that the i^{th} image and the j^{th} image belong to the same image category in the l^{th} prediction processing before the update, eᵢⱼ^{l} represents the updated final probability value that the i^{th} image and the j^{th} image belong to the same image category in the l^{th} prediction processing, and Σₖeᵢₖ^{l-1} represents a sum of the final probability values of all current image pairs of the current image (i.e., the i^{th} image).

At step S26, step S22 is re-performed.

After the updated category relevance is obtained, step S22 and subsequent steps can be re-performed. That is, the image features of a plurality of images can be updated using the updated category relevance. Taking the updated category relevance denoted as εₗ^{gnn}, and the image feature νₗ^{gnn} used in the l^{th} prediction processing as an example, step S22 “updating the image features of a plurality of images using the category relevance” can be expressed as formula (13):

νₗ₊^{gnn}ƒ_{θ}(εₗ^{gnn}νₗ^{gnn}∥(1−εₗ^{gnn})νₗ^{gnn} Formula (13).

In the above formula (13), νₗ₊₁^{gnn} represents the image feature used in the l+1^{th} prediction processing. For other information, reference can be made to the related description in the embodiment disclosed above, and details are not repeated here.

In this way, the image features and the category relevance promote each other and complement each other, and jointly improve respective robustness, so that after a plurality of loops, more accurate feature distribution can be captured, which facilitates improving the accuracy of image category detection.

At step S27, the image category detection result is obtained based on the first probability value.

In an implementation scenario, when the image category detection result includes the image category of the target image, the reference category corresponding to the largest first probability value may be used as the image category of the target image. It can be expressed as formula (14):

ŷ=argmax P(uᵢ)=argmax P(uᵢ^{l}| [symbol] ₀) Formula (14).

In the above formula (14), [symbol] represents an image category of the i^{th} image, P(uᵢ^{L}| [symbol] ₀) represents a first probability value that the i^{th} image belongs to at least one reference category after L times of prediction processing, and [symbol] ₒ represents at least one reference category. Still taking the face recognition scenario as an example, [symbol] ₀ can be a set of “white male”, “white female”, “black male”, and “black female”. Other scenarios can be deduced by parity of reasoning, and no examples are given here.

Different from the foregoing embodiments, the probability information is set to further include a second probability value that the reference image belongs to the at least one reference category. Before the image category detection result is obtained based on the first probability value, when a number of times for which the prediction processing is performed satisfies a preset condition, the category relevance is updated using the probability information, and the step of updating the image features of the plurality of images using the category relevance is re-performed, and when the number of times for which the prediction processing is performed does not satisfy the preset condition, the image category detection result is obtained based on the first probability value. Therefore, when the number of times for which the prediction processing is performed satisfies the preset condition, the category relevance is updated using the first probability value that the target image belongs to at least one reference category and the second probability value that the reference image belongs to at least one reference category, thereby improving the robustness of category similarity, and the image features are updated using the updated category similarity, thereby improving the robustness of image features, and thus enabling category similarity and image features to promote each other and complement each other. Moreover, when the number of times for which the prediction processing is performed does not satisfy the preset condition, the image category detection result is obtained based on the first probability value, which facilitates further improving the accuracy of the image category detection.

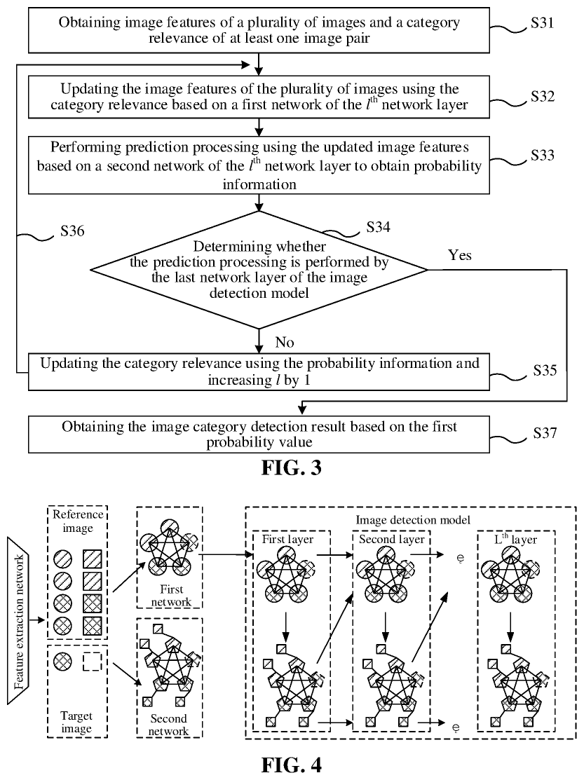

FIG. 3 is a flowchart of yet another embodiment of an image detection method according to embodiments of the disclosure. In the embodiments of the disclosure, image detection is executed by an image detection model, and the image detection model includes at least one (e.g., L) sequentially connected network layers. Each network layer includes a first network (e.g., GNN) and a second network (e.g., CRF), the embodiments of the present disclosure may include the following steps.

At step S31, image features of a plurality of images and a category relevance of at least one image pair are obtained.

In the embodiments of the disclosure, the plurality of images include reference images and target images, any two images in the plurality of images form an image pair, and the category relevance indicates a possibility that images in the image pair belong to a same image category. Reference can be made to the related description in the embodiments disclosed above, and details are not repeated here.

FIG. 4 is a state diagram of an embodiment of an image detection method according to embodiments of the disclosure. As shown in FIG. 4, circles in the first network represent the image features of the images, solid squares in the second network represent the image categories annotated by the reference images, and the image categories of the target images represented by dashed squares represent unknown. Different fills in the squares and circles correspond to different image categories. In addition, pentagons in the second network represent random variables corresponding to image features.

In an implementation scenario, the feature extraction network can be regarded as a network independent of the image detection model. In another implementation scenario, the feature extraction network can also be regarded as a part of the image detection model. In addition, a network structure of the feature extraction network can refer to the related description in the embodiments disclosed above, and details are not repeated here.

At step S32, the image features of the plurality of images are updated using the category relevance based on a first network of a l^{th} network layer

Taking l being 1 as an example, the image features initialized in step S31 can be updated using the category relevance initialized in step S31 to obtain the image features represented by the circles in the first network layer in FIG. 4. When l is other value, other scenarios can be deduced by parity of reasoning with reference to FIG. 4, and no examples are given here.

At step S33, prediction processing is performed using the updated image features based on a second network of the l^{th} network layer to obtain probability information.

In the embodiments of the disclosure, the probability information includes a first probability value that the target image belongs to at least one reference category and a second probability value that the reference image belongs to at least one reference category.

Taking l being 1 as an example, prediction processing can be performed using the image features represented by circles in the first network layer, to obtain the probability information. When l is other value, other scenarios can be deduced by parity of reasoning with reference to FIG. 4, and no examples are given here.

At step S34, whether the prediction processing is executed by a last network layer of the image detection model is determined, if the prediction processing is not executed by the last network layer of the image detection model, step S35 is executed, and if the prediction processing is executed by the last network layer of the image detection model, step S37 is executed.

When the image detection model includes L network layers, it can be determined whether l is less than L. If l is less than L, it is indicated that there is still a network layer that is not subjected to the steps of image feature update and probability information prediction, and the following step S35 can be executed, to use subsequent network layers to continue to update the image features and predict the probability information. If l is not less than L, it is indicated that all network layers of the image detection model are subjected to the steps of image feature update and probability information prediction, and the following step S37 is performed. That is, an image category detection result is obtained based on the first probability value in the probability information.

At step S35, the category relevance is updated using the probability information and 1 is added to l.

Still taking l being 1 as an example, the category relevance can be updated using the probability information predicted using the first network layer, and l is added to l. That is, in this case, l is updated to 2.

For the specific process of updating the category relevance using probability information, reference can be made to the related description in the embodiments disclosed above, and details are not repeated here.

At step S36, step S32 and subsequent steps are re-performed.

Still taking l being 1 as an example, after step S35, l is updated to 2, and step S32 and subsequent steps are re-performed. Referring to FIG. 4, i.e., the image features of a plurality of images are updated using the category relevance based on a first network of the second network layer, and prediction processing is performed using the updated image features based on a second network of the second network layer to obtain probability information, and so on, and no examples are given here.

At step S37, the image category detection result is obtained based on the first probability value.

Reference can be made to the related description in the embodiments disclosed above, and details are not repeated here.

Different from the embodiments above, when the prediction processing is not executed by the last network layer, the category relevance is updated using probability information, and a next network layer is reused to perform the step of updating the image features of the plurality of images using the category relevance. Therefore, the robustness of category similarity can be improved, and the image features are updated using the updated category similarity, thereby improving the robustness of image features, and thus enabling category similarity and image features to promote each other and complement each other, which facilitates further improving the accuracy of image category detection.

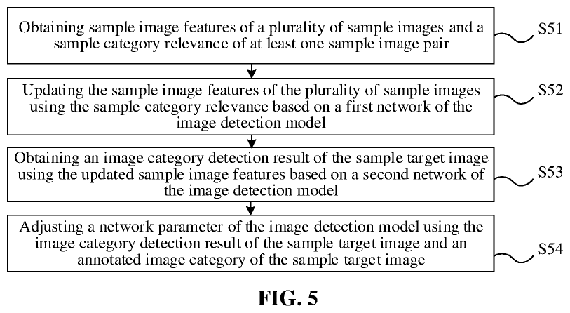

FIG. 5 is a flowchart of an embodiment of A method for training an image detection model according to embodiments of the disclosure. The method may include the following steps.

At step S51, sample image features of a plurality of sample images and a sample category relevance of at least one sample image pair are obtained.

In the embodiments of the disclosure, the plurality of sample images includes a sample reference image and a sample target image, any two sample images in the plurality of sample images form a sample image pair, and the sample category relevance indicates a possibility that images in the sample image pair belong to a same image category. For the process of obtaining the sample image features and the sample category relevance, reference can be made to the process of obtaining the image features and the category relevance in the embodiments disclosed above, and details are not repeated here.

In addition, for the sample target image, the sample reference image, and the image category, reference can also be made to the related description of the target image, the reference image and the image category in the embodiments described above, and details are not repeated here.

In an implementation scenario, the sample image features can be extracted by a feature extraction network. The feature extraction network can be independent of the image detection model in the embodiments of the disclosure, or can be a part of the image detection model in the embodiments of the disclosure, which is not limited here. A structure of the feature extraction network can refer to the related description in the embodiments disclosed above, and details are not repeated here.

It should be noted that, unlike the embodiments disclosed above, in the training process, the image category of the sample target image is known, and the image category to which the sample target image belongs can be annotated on the sample target image. For example, in the face recognition scenario, at least one image category can include: “white female”, “black female”, “white male”, and “black male”. The image category to which the sample target image belongs can be “white female”, which is not limited here. Other scenarios can be deduced by parity of reasoning, and no examples are given here.

At step S52, the sample image features of the plurality of sample images are updated using the sample category relevance based on a first network of the image detection model.

In an implementation scenario, the first network can be a GNN, and the sample category relevance can be taken as the edge of GNN input image data, and the sample image feature can be taken as the point of the GNN input image data, so that the input image data can be processed using the GNN to complete the update of the sample image features. Reference can be made to the related description in the embodiments disclosed above, and details are not repeated here.

At step S53, an image category detection result of the sample target image is obtained using the updated sample image features based on a second network of the image detection model.

In an implementation scenario, the second network may be a conditional random field (CRF) network, and the image category detection result of the sample target image can be obtained using the updated sample image features based on the CRF. The image category detection result may include a first sample probability value that the sample target image belongs to at least one reference category, and the reference category is an image category to which the sample reference image belongs. For example, in the face recognition scenario, at least one reference category may include: “white female”, “black female”, “white male”, and “black male”, and the image category detection result of the sample target image may include a first probability value that the sample target image belongs to the “white female”, a first probability value that the sample target image belongs to the “black women”, a first probability value that the sample target image belongs to the “white male”, and a first probability value that the sample target image belongs to the “black male”. Other scenarios can be deduced by parity of reasoning, and no examples are given here.

At step S54, a network parameter of the image detection model is adjusted using the image category detection result of the sample target image and an annotated image category of the sample target image.

The difference between the image category detection result of the sample target image and the annotated image category of the sample target image can be calculated using a cross entropy loss function, to obtain a loss value of the image detection model, and the network parameter of the image detection model is adjusted accordingly. In addition, when the feature extraction network is independent of the image detection model, the network parameters of the image detection model and the feature extraction network can be adjusted together according to the loss value.

In an implementation scenario, the network parameters are adjusted using the loss value according to Stochastic Gradient Descent (SGD), Batch Gradient Descent (BGD), Mini-Batch Gradient Descent (MBGD), etc. The BGD refers to the use of all samples for parameter update at each iteration. The SGD refers to the use of a sample for parameter update at each iteration. The MBGD refers to the use of a batch of samples for parameter update at each iteration, and details are not repeated here.

In an implementation scenario, a training end condition can also be set, and when the training end condition is satisfied, the training can be ended. The training end condition may include any of the following: the loss value is less than a preset loss threshold, and the current number of training times reaches a preset number threshold (for example, 500 times, 1000 times, etc.), which is not limited here.

In another implementation scenario, prediction processing is performed using the updated sample image features based on the second network to obtain sample probability information, and the sample probability information includes a first sample probability value that the sample target image belongs to at least one reference category and a second sample probability value that the sample reference image belongs to the at least one reference category, so that the image category detection result of the sample target image is obtained based on the first sample probability value. Before the network parameter of the image detection model is adjusted using the image category detection result of the sample target image and an annotated image category of the sample target image, the sample category relevance is updated using the first sample probability value and the second sample probability value, so as to obtain a first loss value of the image detection model using the first sample probability value and the annotated image category of the sample target image, and obtain a second loss value of the image detection model using an actual category relevance between the sample target image and the sample reference image and the updated sample category relevance, thereby adjusting the network parameter of the image detection model based on the first loss value and the second loss value. The method above can adjust the network parameter of the image detection model from the dimension of the category relevance between two images and the dimension of the image category of a single image, which can further improve the accuracy of the image detection model.

In an actual implementation scenario, for the process of performing prediction processing using the updated sample image features based on the second network to obtain sample probability information, reference can be made to the related description of performing prediction processing using the updated image features to obtain the probability information the embodiments disclosed above, and details are not repeated here. In addition, for the process of updating the sample category relevance using the first sample probability value and the second sample probability value, reference can be made to the related description of updating the category relevance using the probability information in the embodiments disclosed above, and details are not repeated here.

In another actual implementation scenario, the first loss value between a first sample probability value and the annotated image category of the sample target image can be calculated using the cross entropy loss function.

In yet another actual implementation scenario, a second loss value between an actual category relevance between the sample target image and the sample reference image and the updated sample category relevance can be calculated using a binary cross entropy loss function. When the image categories of the image pairs are the same, the actual category relevance of the corresponding image pairs can be set to a preset upper limit value (for example, 1). When the image categories of the image pairs are different, the actual category relevance of the corresponding image pairs can be set to a lower limit value (for example, 0). For ease of description, the actual category relevance can be denoted as cᵢⱼ.

In still another actual implementation scenario, weighted processing can be respectively performed on the first loss value and the second loss value respectively using the weights corresponding to the first loss value and the second loss value to obtain a weighted loss value, and the network parameter is adjusted using the weighted loss value. The weight corresponding to the first loss value can be set to 0.5, and the weight corresponding to the second loss value can also be set to 0.5, to indicate that the first loss value and the second loss value are equally important in adjustment of the network parameter. In addition, the corresponding weights can also be adjusted according to the different importance of the first loss value and the second loss value, and no examples are given here.

In the solution above, sample image features of a plurality of sample images and a sample category relevance of at least one sample image pair are obtained, the plurality of sample images includes a sample reference image and a sample target image, any two sample images in the plurality of sample images form a sample image pair, and the sample category relevance indicates a possibility that images in the sample image pair belong to a same image category, and the sample image features of the plurality of sample images are updated using the sample category relevance based on a first network of the image detection model, so that the image category detection result of the sample target image is obtained using the updated sample image features based on a second network of the image detection model, thereby adjusting a network parameter of the image detection model using the image category detection result and the annotated image category of the sample target image. Therefore, by updating sample image features using sample category relevance, sample image features corresponding to images of the same image category can be made closer, and sample image features corresponding to images of different image categories can be divergent, which facilitates improving robustness of the sample image features, and capturing the distribution of sample image features, and in turn facilitates improving the accuracy of image detection model.

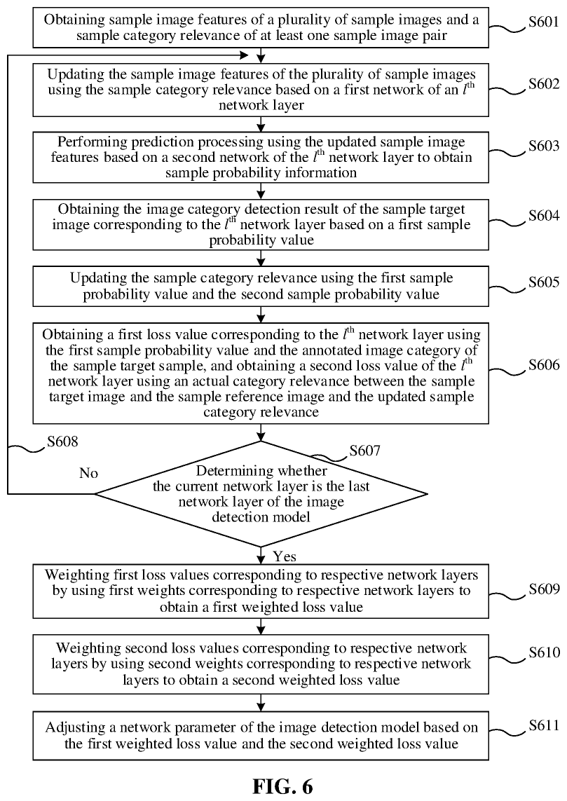

FIG. 6 is a flowchart of another embodiment of A method for training an image detection model according to embodiments of the disclosure. In the embodiments of the disclosure, the image detection model includes at least one (e.g., L) sequentially connected network layers. Each network layer includes a first network and a second network. The method may include the following steps.

At step S601, sample image features of a plurality of sample images and a sample category relevance of at least one sample image pair are obtained.

In the embodiments of the disclosure, the plurality of sample images includes a sample reference image and a sample target image, any two sample images in the plurality of sample images form a sample image pair, and the sample category relevance indicates a possibility that images in the sample image pair belong to a same image category.

Reference can be made to the related steps in the embodiments disclosed above, and details are not repeated here.

At step S602, the sample image features of the plurality of sample images are updated using the sample category relevance based on a first network of a l^{th} network layer.

Reference can be made to the related steps in the embodiments disclosed above, and details are not repeated here.

At step S603, prediction processing is performed using the updated image features based on a second network of the l^{th} network layer to obtain sample probability information.

In the embodiments of the disclosure, the sample probability information includes a first sample probability value that the sample target image belongs to at least one reference category and a second sample probability value that the sample reference image belongs to at least one reference category. The at least one reference category is an image category to which the sample reference image belongs.

Reference can be made to the related steps in the embodiments disclosed above, and details are not repeated here.

At step S604, the image category detection result of the sample target image corresponding to the l^{th} network layer based on a first sample probability value.

For ease of description, the image category detection result of the i^{th} image corresponding to a l^{th} network layer can be recorded as P(uᵢ^{l}| [symbol] ₀). [symbol] ₀ represents a set of at least one image category. Reference can be made to the related description in the embodiments disclosed above, and details are not repeated here.

At step S605, the sample category relevance is updated using the first sample probability value and the second sample probability value.

Reference can be made to the related description in the embodiments disclosed above, and details are not repeated here. For ease of description, the sample category relevance obtained by the l^{th} network layer updating the i^{th} image and the j^{th} image can be denoted as eᵢⱼ^{l}.

At step S606, a first loss value corresponding to the l^{th} network layer is obtained using the first sample probability value and the annotated image category of the sample target sample, and a second loss value of the l^{th} network layer is obtained using an actual category relevance between the sample target image and the sample reference image and the updated sample category relevance.

A first loss value corresponding to the l^{th} network layer can be obtained using the first sample probability value P(uᵢ^{l}| [symbol] ₀) and the image category yᵢ annotated by the sample target image according to the Cross Entropy (CE) loss function. For ease of description, it is denoted as CE(P(uᵢ^{l}| [symbol] ₀), yᵢ), in which the value of i ranges from NK+1 to NK+T. That is, the first loss value is calculated only for the sample target image.

In addition, a second loss value corresponding to the l^{th} network layer can be obtained using the actual category relevance cᵢⱼ between the sample target image and the sample reference image and the updated sample category relevance eᵢⱼ^{l} according to a Binary Cross Entropy (BCE) loss function. . For ease of description, it is denoted as BCE(eᵢⱼ^{l}, cᵢⱼ). The value of i ranges from NK+1 to NK+T. That is, the first loss value is calculated only for the sample target image.

At step S607, whether the current network layer is the last network layer of the image detection model is determined, and if not, step S608 is executed, otherwise, step S609 is executed.

At step S608, step S602 and subsequent steps are re-performed.

When the current network layer is not the last network layer of the image detection model, l can be added to l, so as to use a next network layer of the current network layer to re-perform the step of updating the sample image features of the plurality of sample images using the sample category relevance based on a first network of the image detection model and subsequent steps, until the current network layer is the last network layer of the image detection model. In this process, the first loss value and the second loss value corresponding to each network layer of the image detection model can be obtained.

At step S609, first loss values corresponding to respective network layers are weighted by using first weights corresponding to respective network layers to obtain a first weighted loss value.

In the embodiments of the disclosure, the lower the network layer in the image detection model is, the larger the first weight corresponding to the network layer is. For ease of description, the first weight corresponding to the l^{th} network layer can be denoted as μₗ^{crf}. For example, when l is less than L, the corresponding first weight can be set to 0.2, and when l is equal to L, the corresponding first weight can be set to 1. It can be set according to actual needs. For example, the first weight corresponding to each network layer can be set to a different value on the basis that the later network layer is more important, and the first weight corresponding to each network layer is greater than a first weight corresponding to the previous network layer, which is not limited here. The first weighted loss value can be expressed as formula (15):

$${ℒ}^{crf} = {\sum }_{i = NK + 1}^{NK + T} {\sum }_{j = 1}^{NK} {\sum }_{l = 1}^{L} {μ}_{l}^{crf} CE ( P ( {u}_{i}^{l} \vert {𝓎}_{0} ) , {y}_{i} ) . \qquad Formula ( 15 )$$

At step S610, second loss values corresponding to respective network layers are weighted by using second weights corresponding to respective network layers to obtain a second weighted loss value.

In the embodiments of the disclosure, the lower the network layer in the image detection model is, the larger the second weight corresponding to the network layer is. For ease of description, the second weight corresponding to the l^{th} network layer can be denoted as μₗ^{edge}.For example, when l is less than L, the corresponding second weight can be set to 0.2, and when l is equal to L, the corresponding second weight can be set to 1. It can be set according to actual needs. For example, the second weight corresponding to each network layer can be set to a different value on the basis that the later network layer is more important, and the second weight corresponding to each network layer is greater than a second weight corresponding to the previous network layer, which is not limited here. The second weighted loss value can be expressed as formula (16):

$${ℒ}^{edge} = {\sum }_{i = NK + 1}^{NK + T} {\sum }_{j = 1}^{NK} {\sum }_{l = 1}^{L} {μ}_{l}^{edge} BCE ( {e}_{ij}^{l} , {c}_{ij} ) . \qquad Formula ( 16 )$$

At step S611, a network parameter of the image detection model is adjusted based on the first weighted loss value and the second weighted loss value.

Weighted processing can be respectively performed on the first weighted loss value and the second weighted loss value respectively using the weights corresponding to the first weighted loss value and the second weighted loss value to obtain a weighted loss value, and the network parameter is adjusted using the weighted loss value. For example, the weight corresponding to the first weighted loss value can be set to 0.5, and the weight corresponding to the second weighted loss value can also be set to 0.5, to indicate that the first weighted loss value and the second weighted loss value are equally important in adjustment of the network parameter. In addition, the corresponding weights can also be adjusted according to the different importance of the first weighted loss value and the second weighted loss value, and no examples are given here.

Different from the embodiments above, the image detection model is set to include at least one sequentially connected network layer, and each network layer includes a first network and a second network. When a current network layer is not a last network layer of the image detection model, the step of updating the sample image features using the sample category relevance based on a first network of the image detection model and subsequent steps are re-performed using a next network layer of the current network layer, until the current network layer is the last network layer of the image detection model. First loss values corresponding to respective network layers are weighted by using first weights corresponding to respective network layers to obtain a first weighted loss value. Second loss values corresponding to respective network layers are weighted by using second weights corresponding to respective network layers to obtain a second weighted loss value. The network parameter of the image detection model is adjusted based on the first weighted loss value and the second weighted loss value, and the lower the network layer in the image detection model is, the larger the first weight and the second weight corresponding to the network layer are, so as to obtain the loss value corresponding to each network layer of the image detection model. Moreover, the weight corresponding to the later network layer can be set to be larger, and then the data obtained by the processing of each network layer can be fully utilized to adjust the network parameter of image detection, facilitating improving the accuracy of the image detection model.

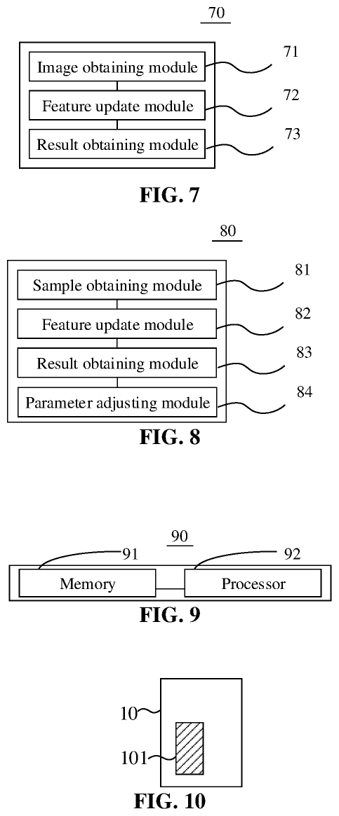

FIG. 7 is a diagram of a structure of an embodiment of an image detection apparatus 70 according to embodiments of the disclosure. The image detection apparatus 70 includes an image obtaining module 71, a feature update module 72, and a result obtaining module 73. The image obtaining module 71 is configured to obtain image features of a plurality of images and a category relevance of at least one image pair. The plurality of images include reference images and target images, any two images in the plurality of images form an image pair, and the category relevance indicates a possibility that images in the image pair belong to a same image category. The feature update module 72 is configured to update the image features of the plurality of images using the category relevance. The result obtaining module 73 is configured to obtain an image category detection result of the target image using the updated image features.

In the solution above, image features of a plurality of images and a category relevance of at least one image pair are obtained, the plurality of images include reference images and target images, any two images in the plurality of images form an image pair, and the category relevance indicates a possibility that images in the image pair belong to a same image category, the image features are updated using the category relevance, and an image category detection result of the target image is obtained using the updated image features. Therefore, by updating image features using category relevance, image features corresponding to images of the same image category can be made closer, and image features corresponding to images of different image categories can be divergent, which facilitates improving robustness of the image features, and capturing the distribution of image features, and in turn facilitates improving the accuracy of image category detection.

In some disclosed embodiments, the result obtaining module 73 includes a probability prediction sub-module, configured to perform prediction processing using the updated image features to obtain probability information. The probability information includes a first probability value that the target image belongs to at least one reference category, and the reference category is an image category to which the reference image belongs. The result obtaining module 73 includes a result obtaining sub-module, configured to obtain the image category detection result based on the first probability value. The image category detection result is used for indicating an image category to which the target image belongs.

In some disclosed embodiments, the probability information further includes a second probability value that the reference image belongs to the at least one reference category. The image detection apparatus 70 further includes a relevance update module, configured to update the category relevance using the probability information when a number of times for which the prediction processing is performed satisfies a preset condition, and re-performing the step of updating the image features using the category relevance in combination with the feature update module 72. The result obtaining sub-module is further configured to obtain the image category detection result based on the first probability value when the number of times for which the prediction processing is performed does not satisfy the preset condition.

In some disclosed embodiments, the category relevance includes a final probability value that each pair of images belong to a same image category. The relevance update module includes an image division sub-module, configured to take each of the plurality of images as a current image, and take the image pairs including the current image as current image pairs. The relevance update module includes a probability statistics sub-module, configured to obtain the sum of the final probability values of all the current image pairs of the current image as a probability sum of the current image. The relevance update module includes a probability obtaining sub-module, configured to respectively obtain a reference probability value that the images in each image pair of current image pairs belong to the same image category using the first probability value and the second probability value. The relevance update module includes a probability adjusting sub-module, configured to adjust the final probability value of each image pair of current image pairs respectively using the probability sum and the reference probability value.

In some disclosed embodiments, the probability prediction sub-module includes a prediction category unit, configured to predict the prediction categories to which the target image and the reference image belong using the updated image features. The prediction categories belong to at least one reference category. The probability prediction sub-module includes a first matching degree obtaining unit, configured to obtain a category comparison result and a feature similarity of the image pair, and a first matching degree between the category comparison result and the feature similarity of the image pair for each image pair. The category comparison result indicates whether respective prediction categories to which the images in the image pair belong are the same, and the feature similarity indicates a similarity between image features of the images in the image pair. The probability prediction sub-module includes a second matching degree obtaining unit, configured to obtain a second matching degree between the prediction category and the reference category of the reference image based on the prediction category to which the reference image belongs and the reference category. The probability prediction sub-module includes a probability information obtaining unit, configured to obtain the probability information using the first matching degree and the second matching degree.

In some disclosed embodiments, when the category comparison result is that the prediction categories are the same, the feature similarity may be positively correlated with the first matching degree. When the category comparison result is that the prediction categories are different, the feature similarity may be negatively correlated with the first matching degree. A second matching degree when the prediction category is the same as the reference category may be greater than a second matching degree when the prediction category is different from the reference category.

In some disclosed embodiments, the prediction category unit is further configured to predict the prediction category to which the image belongs using the updated image features based on a conditional random field network.

In some disclosed embodiments, the probability information obtaining unit is configured to obtain the probability information using the first matching degree and the second matching degree based on loopy belief propagation.

In some disclosed embodiments, the preset condition may include: the number of times for which the prediction processing is performed does not reach a preset threshold.

In some disclosed embodiments, the step of updating the image features using the category relevance may be executed by a graph neural network.

In some disclosed embodiments, the feature update module 72 includes a feature obtaining sub-module, configured to obtain an intra-category image feature and an inter-category image feature using the category relevance and the image features. The feature update module 72 includes a feature conversion sub-module, configured to perform feature conversion using the intra-category image feature and the inter-category image feature to obtain the updated image features.

In some disclosed embodiments, the image detection apparatus 70 further includes an initialization module, further configured to determine an initial category relevance of the image pair as a preset upper limit value when the images in the image pair belong to a same image category, determine the initial category relevance of the image pair as a preset lower limit value when the images in the image pair belong to different image categories, and determine the initial category relevance of the image pair as a preset value between the preset upper limit value and the preset lower limit value when at least one image of the image pair is the target image.

FIG. 8 is a diagram of a structure of an embodiment of an image detection model training apparatus 80 according to embodiments of the disclosure. The image detection model training apparatus 80 includes a sample obtaining module 81, a feature update module 82, a result obtaining module 83, and a parameter adjusting module 84. The sample obtaining module 81 is configured to obtain sample image features of a plurality of sample images and a sample category relevance of at least one sample image pair. The plurality of sample images includes a sample reference image and a sample target image, any two sample images in the plurality of sample images form a sample image pair, and the sample category relevance indicates a possibility that images in the sample image pair belong to a same image category. The feature update module 82 is configured to update the sample image features of the plurality of sample images using the sample category relevance based on a first network of the image detection model. The result obtaining module 83 is configured to obtain an image category detection result of the sample target image using the updated sample image features based on a second network of the image detection model. The parameter adjusting module 84 is configured to adjust a network parameter of the image detection model using the image category detection result of the sample target image and an annotated image category of the sample target image.

In the solution above, sample image features of a plurality of sample images and a sample category relevance of at least one sample image pair are obtained, the plurality of sample images includes a sample reference image and a sample target image, any two sample images in the plurality of sample images form a sample image pair, and the sample category relevance indicates a possibility that images in the sample image pair belong to a same image category, and the sample image features of the plurality of sample images are updated using the sample category relevance based on a first network of the image detection model, so that the image category detection result of the sample target image is obtained using the updated sample image features based on a second network of the image detection model, thereby adjusting a network parameter of the image detection model using the image category detection result and the annotated image category of the sample target image. Therefore, by updating sample image features using sample category relevance, sample image features corresponding to images of the same image category can be made closer, and sample image features corresponding to images of different image categories can be divergent, which facilitates improving robustness of the sample image features, and capturing the distribution of sample image features, and in turn facilitates improving the accuracy of image detection model.

In some disclosed embodiments, the result obtaining module 83 includes a probability information obtaining sub-module, configured to perform prediction processing using the updated sample image features based on the second network to obtain sample probability information. The sample probability information includes a first sample probability value that the sample target image belongs to at least one reference category and a second sample probability value that the sample reference image belongs to the at least one reference category. The reference category is an image category to which the sample reference image belongs. The result obtaining module 83 includes a detection result obtaining sub-module, configured to obtain the image category detection result of the sample target image based on the first sample probability value. The image detection model training apparatus 80 further includes a relevance update module, configured to update the sample category relevance using the first sample probability value and the second sample probability value. The parameter adjusting module 84 includes a first loss calculation sub-module, configured to obtain a first loss value of the image detection model using the first sample probability value and the annotated image category of the sample target image. The parameter adjusting module 84 includes a second loss calculation sub-module, configured to obtain a second loss value of the image detection model using an actual category relevance between the sample target image and the sample reference image and the updated sample category relevance. The parameter adjusting module 84 includes a parameter adjustment sub-module, configured to adjust the network parameter of the image detection model based on the first loss value and the second loss value.

In some disclosed embodiments, the image detection model includes at least one sequentially connected network layer. Each network layer includes a first network and a second network. The feature update module 82 is further configured to use, when a current network layer is not a last network layer of the image detection model, a next network layer of the current network layer to re-perform the step of updating the sample image features using the sample category relevance based on a first network of the image detection model and subsequent steps, until the current network layer is the last network layer of the image detection model. The parameter adjustment sub-module includes a first weighting unit, configured to respectively weight a first loss value corresponding to each network layer by using a first weight corresponding to each network layer to obtain a first weighted loss value. The parameter adjustment sub-module includes a second weighting unit, configured to weight a second loss value corresponding to each network layer by using a second weight corresponding to each network layer to obtain a second weighted loss value. The parameter adjustment sub-module includes a parameter adjustment unit, configured to adjust the network parameter of the image detection model based on the first weighted loss value and the second weighted loss value. The lower the network layer in the image detection model is, the larger the first weight and the second weight corresponding to the network layer are.

FIG. 9 is a diagram of a structure of an embodiment of an electronic device 90 91 and a processor 92 coupled to each other. The processor 92 is configured to execute program instructions stored in the memory 91 to implement steps in any image detection method embodiment or steps in any image detection model training method embodiment. In an implementation scenario, the electronic device 90 may include, but is not limited to, a microcomputer and a server. In addition, the electronic device 90 may also include mobile devices such as a notebook computer and a tablet computer, or the electronic device 90 may also be a surveillance camera, etc., which is not limited here.

The processor 92 is further configured to control itself and the memory 91 to implement the steps in any image detection method embodiment, or to implement the steps in any image detection model training method embodiment. The processor 92 may also be referred to as a Central Processing Unit (CPU). The processor 92 may be an integrated circuit chip with signal processing capabilities. The processor 92 may also be a general-purpose processor, a Digital Signal Processor (DSP), an Application Specific Integrated Circuit (ASIC), a Field-Programmable Gate Array (FPGA), or other programmable logic devices, discrete gates or transistor logic devices, discrete hardware components. The general-purpose processor may be a microprocessor or the processor may also be any conventional processor, etc. In addition, the processor 92 may be jointly implemented by the integrated circuit chip.

The solution above can improve the accuracy of image category detection.

FIG. 10 is a diagram of a structure of an embodiment of a computer readable storage medium 100 according to embodiments of the disclosure. The computer readable storage medium 100 stores program instructions 101 run by a processor. The program instructions 101 are configured to implement the steps in any image detection method embodiment, or to implement the steps in any image detection model training method embodiment.

The solution above can improve the accuracy of image category detection.

In some embodiments, the functions or modules contained in the apparatus provided in the embodiments of the disclosure can be configured to execute the method described in the foregoing method embodiments. For implementation of the apparatus, reference can be made to the description of the foregoing method embodiments. For brevity, details are not repeated here.

A computer program product of the image detection method or the method for training the image detection model provided by the embodiments of the disclosure includes a computer readable storage medium having program codes stored thereon, and instructions included in the program codes can be configured to execute the steps in any image detection method embodiment or the steps in any image detection model training method embodiment. Reference may be made to the foregoing method embodiments, and the details are not repeated here.

The embodiments of the disclosure also provide a computer program. The computer program, when executed by a processor, implements any method according to the foregoing embodiments. The computer program product may be implemented by hardware, software, or a combination thereof. In an optional embodiment, the computer program product is embodied as a computer storage medium. In another optional embodiment, the computer program product is embodied as a software product, such as a Software Development Kit (SDK).

In the method above, image features of a plurality of images and a category relevance of at least one image pair are obtained, the plurality of images include reference images and target images, any two images in the plurality of images form an image pair, and the category relevance indicates a possibility that images in the image pair belong to a same image category, the image features are updated using the category relevance, and an image category detection result of the target image is obtained using the updated image features. Therefore, by updating image features using category relevance, image features corresponding to images of the same image category can be made closer, and image features corresponding to images of different image categories can be divergent, which facilitates improving robustness of the image features, and capturing the distribution of image features, and in turn facilitates improving the accuracy of image category detection.

The above description of various embodiments tends to emphasize the differences between the various embodiments, the same or similarities can be referred to each other. For brevity, details are not repeated here.

In the several embodiments provided in the disclosure, it should be understood that, the disclosed method and apparatus may be implemented in another manner For example, the apparatus embodiments described above are merely exemplary. For example, the division of the modules or units is merely the division of logic functions, and may use other division manners during actual implementation. For example, units or components may be combined, or may be integrated into another system, or some features may be omitted or not performed. In addition, the coupling, or direct coupling, or communication connection between the displayed or discussed components may be the indirect coupling or communication connection through some interfaces, apparatuses, or units, and may be electrical, mechanical or of other forms.

The units described as separate components may or may not be physically separated, and the components displayed as units may or may not be physical units, and may be located in one place or may be distributed over network units. Some or all of the units may be selected based on actual needs to achieve the objectives of the solutions of the implementation of the disclosure.

In addition, functional units in the embodiments of the disclosure may be integrated into one processing unit, or each of the units may be physically separated, or two or more units may be integrated into one unit. The integrated unit may be implemented in the form of hardware, or may be implemented in a form of a software functional unit.

If implemented in the form of software functional units and sold or used as an independent product, the integrated unit may also be stored in a computer readable storage medium. Based on such an understanding, the technical solutions provided by the embodiments of the disclosure essentially or the part that contributes to the existing technology or a part of the technical solution can be embodied in the form of a software product, and the computer software product is stored in a storage medium, including several instructions that cause a computer device (which can be a personal computer, a server, or a network device, etc.) or a processor to execute all or part of the steps of the method described in each embodiment of the disclosure. The foregoing storage medium includes: a USB flash drive, a mobile hard disk drive, a Read-Only Memory (ROM), a Random Access Memory (RAM), a magnetic disk, or an optical disk and other media that may store program codes.

### INDUSTRIAL APPLICABILITY

In the embodiments of the disclosure, image features of a plurality of images and a category relevance of at least one image pair are obtained, and the plurality of images include reference images and target images, any two images in the plurality of images form an image pair, and the category relevance indicates a possibility that images in the image pair belong to a same image category. The image features of the plurality of images are updated using the category relevance. An image category detection result of the target image is obtained using the updated image features. In this way, image features corresponding to images of the same image category can be made closer, and image features corresponding to images of different image categories can be divergent, which facilitates improving robustness of the image features, and capturing the distribution of image features, and in turn facilitates improving the accuracy of image category detection.

1. An image detection method, comprising:
obtaining image features of a plurality of images and a category relevance of at least one image pair, wherein the plurality of images comprise reference images and target images, any two images in the plurality of images form an image pair, and the category relevance indicates a possibility that images in the image pair belong to a same image category;
updating the image features of the plurality of images using the category relevance; and
obtaining an image category detection result of the target image using the updated image features.

2. The method of claim 1, wherein obtaining the image category detection result of the target image using the updated image features comprises:
performing prediction processing using the updated image features to obtain probability information, wherein the probability information comprises a first probability value that the target image belongs to at least one reference category, and the reference category is an image category to which the reference image belongs; and
obtaining the image category detection result based on the first probability value, wherein the image category detection result is used for indicating an image category to which the target image belongs.

3. The method of claim 2, wherein the probability information further comprises a second probability value that the reference image belongs to the at least one reference category;
before obtaining the image category detection result based on the first probability value, the method further comprises:
when a number of times for which the prediction processing is performed satisfies a preset condition, updating the category relevance using the probability information, and re-performing the step of updating the image features of the plurality of images using the category relevance; and
obtaining the image category detection result based on the first probability value comprises:
when the number of times for which the prediction processing is performed does not satisfy the preset condition, obtaining the image category detection result based on the first probability value.

4. The method of claim 3, wherein the category relevance comprises a final probability value that each pair of images belong to a same image category; and updating the category relevance using the probability information comprises:
taking each of the plurality of images as a current image, and taking image pairs comprising the current image as current image pairs;
obtaining a sum of the final probability values of all the current image pairs of the current image as a probability sum of the current image;
respectively obtaining a reference probability value that the images in each image pair of current image pairs belong to the same image category using the first probability value and the second probability value; and
adjusting the final probability value of each image pair of current image pairs respectively using the probability sum and the reference probability value.

5. The method of claim 2, wherein performing prediction processing using the updated image features to obtain probability information comprises:
predicting a prediction category to which the image belongs using the updated image features, wherein the prediction category belongs to the at least one reference category;
for each image pair, obtaining a category comparison result and a feature similarity of the image pair, and obtaining a first matching degree between the category comparison result and the feature similarity of the image pair, wherein the category comparison result indicates whether respective prediction categories to which the images in the image pair belong are the same, and the feature similarity indicates a similarity between image features of the images in the image pair;
obtaining a second matching degree between the prediction category and the reference category of the reference image based on a prediction category to which the reference image belongs and the reference category; and
obtaining the probability information using the first matching degree and the second matching degree.

6. The method of claim 5, wherein when the category comparison result is that the prediction categories are the same, the feature similarity is positively correlated with the first matching degree; when the category comparison result is that the prediction categories are different, the feature similarity is negatively correlated with the first matching degree, and the second matching degree when the prediction category is the same as the reference category is greater than the second matching degree when the prediction category is different from the reference category.

7. The method of claim 5, wherein predicting the prediction category to which the image belongs using the updated image features comprises:
predicting the prediction category to which the image belongs using the updated image features based on a conditional random field network.

8. The method of claim 5, wherein obtaining the probability information using the first matching degree and the second matching degree comprises:
obtaining the probability information using the first matching degree and the second matching degree based on loopy belief propagation.

9. The method of claim 3, wherein
the preset condition comprises: the number of times for which the prediction processing is performed does not reach a preset threshold.

10. The method of claim 1, wherein the step of updating the image features of the plurality of images using the category relevance is performed by a graph neural network (GNN).

11. The method of claim 1, wherein updating the image features of the plurality of images using the category relevance comprises:
obtaining an intra-category image feature and an inter-category image feature using the category relevance and the image features; and
performing feature conversion using the intra-category image feature and the inter-category image feature to obtain the updated image features.

12. The method of claim 1, further comprising:
when the images in the image pair belong to a same image category, determining an initial category relevance of the image pair as a preset upper limit value;
when the images in the image pair belong to different image categories, determining the initial category relevance of the image pair as a preset lower limit value; and
when at least one image of the image pair is the target image, determining the initial category relevance of the image pair as a preset value between the preset upper limit value and the preset lower limit value.

13. A method for training an image detection model, comprising:
obtaining sample image features of a plurality of sample images and a sample category relevance of at least one sample image pair, wherein the plurality of sample images comprise sample reference images and sample target images, any two sample images in the plurality of sample images form a sample image pair, and the sample category relevance indicates a possibility that images in the sample image pair belong to a same image category;
updating the sample image features of the plurality of sample images using the sample category relevance based on a first network of the image detection model;
obtaining an image category detection result of the sample target image using the updated sample image features based on a second network of the image detection model; and
adjusting a network parameter of the image detection model using the image category detection result of the sample target image and an annotated image category of the sample target image.

14. The method of claim 13, wherein obtaining an image category detection result of the sample target image using the updated sample image features based on a second network of the image detection model comprises:
performing prediction processing using the updated sample image features based on the second network to obtain sample probability information, wherein the sample probability information comprises a first sample probability value that the sample target image belongs to at least one reference category and a second sample probability value that the sample reference image belongs to the at least one reference category, and the reference category is an image category to which the sample reference image belongs; and
obtaining an image category detection result of the sample target image based on the first sample probability value;
before the adjusting a network parameter of the image detection model using the image category detection result of the sample target image and an annotated image category of the sample target image, the method further comprises:
updating the sample category relevance using the first sample probability value and the second sample probability value; and
adjusting a network parameter of the image detection model using the image category detection result of the sample target image and an annotated image category of the sample target image comprises:
obtaining a first loss value of the image detection model using the first sample probability value and the annotated image category of the sample target image;
obtaining a second loss value of the image detection model using an actual category relevance between the sample target image and the sample reference image and the updated sample category relevance; and
adjusting the network parameter of the image detection model based on the first loss value and the second loss value.

15. The method of claim 14, wherein the image detection model comprises at least one sequentially connected network layer, and each network layer comprises a first network and a second network; and before adjusting the network parameter of the image detection model based on the first loss value and the second loss value, the method further comprises:
when a current network layer is not a last network layer of the image detection model, using a next network layer of the current network layer to re-perform the step of updating the sample image features of the plurality of sample images using the sample category relevance based on a first network of the image detection model and subsequent steps, until the current network layer is the last network layer of the image detection model;
adjusting the network parameter of the image detection model based on the first loss value and the second loss value comprises:
weighting first loss values corresponding to respective network layers by using first weights corresponding to respective network layers to obtain a first weighted loss value;
weighting second loss values corresponding to respective network layers by using second weights corresponding to respective network layers to obtain a second weighted loss value; and
adjusting the network parameter of the image detection model based on the first weighted loss value and the second weighted loss value;
wherein the lower the network layer in the image detection model is, the larger the first weight and the second weight corresponding to the network layer are.

16. An image detection apparatus, comprising:
a memory for storing instructions executable by a processor; and
the processor configured to execute the instructions to perform operations of:
obtaining image features of a plurality of images and a category relevance of at least one image pair, wherein the plurality of images comprise reference images and target images, any two images in the plurality of images form an image pair, and the category relevance indicates a possibility that images in the image pair belong to a same image category;
updating the image features of the plurality of images using the category relevance; and
obtaining an image category detection result of the target image using the updated image features.

17. The apparatus of claim 16, wherein obtaining the image category detection result of the target image using the updated image features comprises:
performing prediction processing using the updated image features to obtain probability information, wherein the probability information comprises a first probability value that the target image belongs to at least one reference category, and the reference category is an image category to which the reference image belongs; and
obtaining the image category detection result based on the first probability value, wherein the image category detection result is used for indicating an image category to which the target image belongs.

18. An electronic device, comprising a memory and a processor coupled to each other, wherein the processor is configured to execute program instructions stored in the memory to implement the method of claim 13.

19. A non-transitory computer readable storage medium having stored thereon program instructions that when executed by a processor, implement the method of claim 1.

20. A non-transitory computer readable storage medium having stored thereon program instructions that when executed by a processor, implement the method of claim 13.
